(19) United States
(12) Patent Application Publication
(10) Pub. No.: US 2006/0191749 A1
(43) Pub. Date: Aug. 31, 2006

(54) Hall door apparatus of elevator

(76) Inventors: Koyu Sasaki, Fuchu-shi (JP); Seiichi Someya, Niiza-shi (JP); Takehito Nishida, Yokohama-shi (JP); Satoshi Takasawa, Himeji-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/392,494

(22) Filed: Mar. 30, 2006

Related U.S. Application Data
(63) Continuation of application No. PCT/JP04/14395, filed on Sep. 30, 2004.

(30) Foreign Application Priority Data
Sep. 30, 2003 (JP) 2003-342015
Dec. 9, 2003 (JP) 2003-410833

(51) Int. Cl. B66B 3/00

(52) U.S. Cl. 187/391

(57) ABSTRACT

A hall door apparatus of an elevator includes a gate frame, a doorsill, and a door panel. The gate frame is provided in an entrance port between an elevator hall of a building and an elevator shaft. The doorsill is arranged in a lower portion of the gate frame. The door panel is of a biparting door type, and is set on the doorsill to face the gate frame. Sealing members are made of an elastic material such as a rubber, and seal gaps between the door panel and a jamb portion and header panel portion of the gate frame, and between the door panel and the doorsill.

### CROSS-REFERENCE TO RELATED APPLICATIONS

This is a Continuation Application of PCT Application No. PCT/JP2004/014395, filed Sep. 30, 2004, which was published under PCT Article 21(2) in Japanese.

This application is based upon and claims the benefit of priority from prior Japanese Patent Applications No. 2003-342015, filed Sep. 30, 2003; and No. 2003-410833, filed Dec. 9, 2003, the entire contents of both of which are incorporated herein by reference.

### BACKGROUND OF THE INVENTION

1. Field of the Invention

The present invention relates to a hall door apparatus of an elevator to shut flow of smoke at fire by improving airtightness between an elevator shaft and elevator halls.

2. Description of the Related Art

In an elevator, there is provided an entrance gate as an entrance port to a cage between an elevator hall of a building and an elevator shaft. A gate frame and a doorsill are attached to this entrance door. A door device is set on the doorsill. The door device opens when the cage moving in the elevator shaft stops a floor at this elevator hall, and the door device closes before the cage leaves this elevator hall.

There is a slight gap between the door device and the gate frame or the doorsill. When a fire happens in an elevator hall, the smoke flows into the elevator shaft through the gap. In this case, the elevator shaft works as a chimney that guides the smoke to ascend, and a force of fire might escalate.

Therefore, it is increasing numbers of the elevator that is installed a hall door apparatus to block the smoke flowing from the elevator hall into the elevator shaft. This apparatus has a screen on the front of the gate frame. The screen is developed from a stored state to cover the whole front face of the gate frame including the door device at the fire.

However, in a hall door apparatus which has a screen, it is difficult to quickly shut inflow of smoke into an elevator shaft, because the screen is developed from a stored state to cover the whole front face of a gate frame and its operation takes much time. The screen has a low smokeproof capability against the inflow of the smoke, and much cost is required. Since the screen in the stored state is placed in the front face of the gate frame, the hall door apparatus mars beautiful appearance of elevator hall in some case.

### BRIEF SUMMARY OF THE INVENTION

The hall door apparatus requires a sufficient sealing tightness to shut the inflow of the smoke. When the hall door apparatus is attached to an elevator on the spot, fine adjustment is preferably performed to secure the sufficient seal-tightness.

The present invention provides a hall door apparatus of an elevator, which improves airtightness between an elevator hall and an elevator shaft to thereby prevent the elevator shaft from being worked as a chimney, inexpensively and securely without spoiling the appearance of the elevator.

A hall door apparatus of an elevator according to a present invention has a gate frame, a doorsill, a door panel, and a sealing member. The gate frame is provided in an entrance port between an elevator hall and an elevator shaft in a building. The doorsill is arranged in a lower portion of this gate frame. The door panel is of a biparting door type and is set on the doorsill to face the gate frame. The sealing member is an elastic material which seals a gap between the door panel and at least the gate frame or the doorsill.

Moreover, a hall door apparatus of an elevator in another aspect of the present invention is installed in an entrance port between an elevator hall and an elevator shaft in a building. The hall door apparatus has a gate frame, a doorsill, a door panel, and a sealing member. The gate frame has a pair of jamb portions disposed on opposite sides, and a header panel portion stretched between upper end portions of the jamb portions. The doorsill is arranged in a lower portion of this gate frame. The door panel is of a biparting door type, and is set on the doorsill to face the gate frame. The sealing member is made of an elastic material, and seals gaps between the door panel and the jamb portions and header panel portion of the gate frame and between the door panel and the doorsill, and a gap between doorstop portions of the door panel.

Furthermore a hall door apparatus of an elevator according to still another aspect of the present invention has a gate frame, a doorsill, a door panel, and a sealing member. The gate frame is provided in an entrance port between an elevator hall and an elevator shaft in a building. The doorsill is arranged in a lower portion of this gate frame. The door panel is of a one-side sliding door type, and is set on the doorsill to face the gate frame. The sealing member is made of an elastic material, and seals a gap between the door panel and at least the gate frame or doorsill.

Additionally, a hall door apparatus of an elevator according to a further aspect of the present invention includes a gate frame, a doorsill, a door panel, and a sealing member. The gate frame is provided in an entrance part between an elevator hall and an elevator shaft in a building. The gate frame has a pair of jamb portions disposed on opposite sides and an header panel portion stretched between upper end portions of the jamb portions. The doorsill is arranged in a lower portion of this gate frame. The door panel is of a one-side sliding door type, and is set on the doorsill to face the gate frame. The sealing member is made of an elastic material, and seals gaps between the door panel and the jamb portions and header panel portion of the gate frame and between the door panel and the doorsill, and a gap between overlapping portions of side edge portions of the door panel.

In this case, the sealing member which seals the gap between the door panel and the header panel portion of the gate frame has a base portion, and a lip portion. The base portion is bonded to a press plate, and fixed to the header panel portion together with the press plate via a fastening member. The lip portion extends continuously from the base portion, and keeps an inclined posture with respect to the surface of the door panel while a distal-end edge portion of the lip portion is curved to warp as arc, and elastically comes into contact with the surface of the door panel. As a result, the gap between the door panel and the header panel portion of the gate frame is sealed.

Moreover, the sealing member which seals the gap between the door panel and the jamb portion of the gate frame has a base portion and a lip portion. The base portion is bonded to a press plate, and fixed to an end face of the door panel together with the press plate via a fastening member. The lip portion extends continuously from the base portion, and keeps an inclined posture against the surface of the jamb portion while a side surface of the lip portion is curved to warp as arc, and elastically comes into contact with a corner portion of the jamb portion. As a result, the gap between the door panel and the jamb portion of the gate frame is sealed.

Furthermore, the sealing member which seals the gap between the door panel and the doorsill has a base portion and a lip portion. The base portion is bonded to a press plate, and fixed to the door panel together with the press plate via a fastening member. The lip portion extends continuously from the base portion, and keeps an inclined posture against a top of the doorsill while a distal-end edge portion of the lip portion is curved to warp as arc, and elastically comes into contact with the top of the doorsill. As a result, the gap between the door panel and the doorsill is sealed.

Additionally, in a case where the fastening member fixes to the header panel portion the sealing member which seals the gap between the door panel and the header panel portion of the gate frame, the fastening member is inserted from the center of the elevator shaft into the header panel portion. In a case where the fastening member fixes to the door panel the sealing member which seals the gap between the door panel and the jamb portion of the gate frame, the fastening member is inserted from the center of the elevator shaft into the door panel. In a case where the fastening member fixes to the door panel the sealing member which seals the gap between the door panel and the doorsill, the fastening member is inserted from the center of the elevator shaft into the door panel.

The sealing member is made of at least one selected from the group consisting of fluorine-based rubber, silicon rubber, vinyl chloride, and ethylene propylene rubber. The sealing members provided with respect to the door panel and the header panel portion, the door panel and the gate frame, or the door panel and the doorsill are made of an ethylene propylene rubber.

Moreover, the press plate has a substantially U-shaped vertical section, and sandwiches the sealing member in this U-shape to hold the sealing member. In the doorsill, a recessed portion is formed over a predetermined span in a longitudinal direction of an upper portion of the doorsill. The doorsill is provided with a guide groove. The doorsill is provided with a plugging member which closes the guide groove in a zone crossing the gate frame.

In the sealing member, a door pocket shield member seals the gap between the door panel and the jamb portion of the gate frame, and has an oval attachment hole which is long along a vertical direction of the door panel. In the sealing member, a doorsill shield member seals the gap between the door panel and the doorsill, and has an oval attachment hole which is long along a direction from a proximal end of the member fixed to the door panel to a distal end of the member brought into contact with the top of the doorsill.

### BRIEF DESCRIPTION OF THE SEVERAL VIEWS OF THE DRAWING

FIG. 1 is a front view of an entrance port of an elevator as viewed from an elevator shaft in a first embodiment of the present invention;

FIG. 2 is a sectional view cut along the A-A line shown in FIG. 1;

FIG. 3 is a sectional view cut along the B-B line shown in FIG. 1;

FIG. 4 is a sectional view cut along the C-C line shown in FIG. 1;

FIG. 5 is a sectional view cut along the D-D line shown in FIG. 1;

FIG. 6 is a sectional view cut along the E-E line shown in FIG. 1;

FIG. 7 is a sectional view showing a hall door apparatus of an elevator in a second embodiment of the present invention;

FIG. 8 is a sectional view cut along the F-F line shown in FIG. 7;

FIG. 9 is a perspective view of a guide member attached in a door panel shown in FIG. 7;

FIG. 10 is an enlarged sectional view of the H part shown in FIG. 7;

FIG. 11 is an enlarged sectional view of the I part shown in FIG. 7;

FIG. 12 is an enlarged sectional view of the J part shown in FIG. 7;

FIG. 13 is a plan view showing a doorsill in the second embodiment;

FIG. 14 is a sectional view cut along the K-K line shown in FIG. 13;

FIG. 15 is a sectional view cut along the L-L line shown in FIG. 13;

FIG. 16 is a sectional view showing a third embodiment of the present invention;

FIG. 17 is a sectional view showing a fourth embodiment of the present invention;

FIG. 18 is a sectional view showing a fifth embodiment of the present invention;

FIG. 19 is a perspective view showing a gate frame and a hall door assembled by a method of assembling an elevator provided with a smokeproof device as viewed from an elevator shaft in a sixth embodiment of the present invention;

FIG. 20 is a sectional view cut along the F2-F2 line shown in FIG. 19 and showing a periphery of a doorstop portion of the hall door;

FIG. 21 is a sectional view cut along the F3-F3 line shown in FIG. 19 and showing an upper portion of the hall door and a header panel portion of a gate frame;

FIG. 22 is a sectional view cut along the F4-F4 line shown in FIG. 19 and showing a periphery of a door pocket side of the hall door;

FIG. 23 is a sectional view cut along the F5-F5 line shown in FIG. 19 and showing a lower portion of the hall door and a doorsill;

FIG. 24 is an enlarged exploded perspective view of the door pocket side of a header panel shield member in a case where the hall door shown in FIG. 19 is opened;

FIG. 25 is a partially enlarged exploded perspective view of a periphery of an attachment hole in a door pocket shield member shown in FIG. 19;

FIG. 26 is a partially enlarged exploded perspective view of a periphery of an attachment hole in a doorsill shield member shown in FIG. 19; and

FIG. 27 is a flowchart showing steps of an assembly procedure of an elevator provided with a smoke shut-off device.

### DETAILED DESCRIPTION OF THE INVENTION

Embodiments of the present invention will be described hereinafter with reference to the drawings.

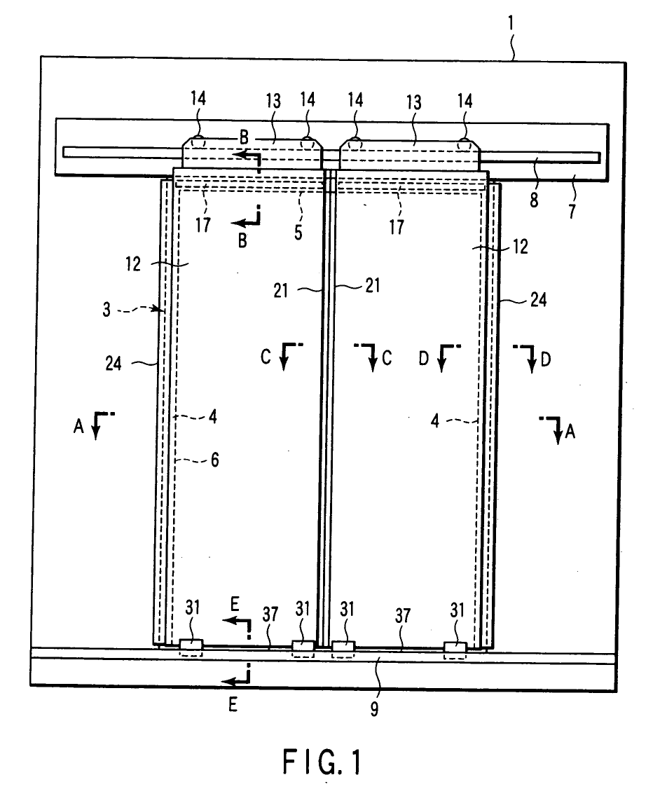

In a first embodiment of the present invention, a hall door apparatus of an elevator will be described with reference to FIGS. 1 to 6. The hall door apparatus of the elevator includes a gate frame 3, a doorsill 9, door panels 12, and sealing members 17, 21, 24, and 37. FIG. 1 is a front view of an entrance port of the elevator as viewed on an elevator shaft side. This entrance port is provided with a building wall 1. The gate frame 3 is attached to an opening formed in this building wall 1. The gate frame 3 has a gate shape, and includes a pair of jamb portions 4, which extends in a vertical direction and is set on opposite sides, and a header panel portion 5, which is stretched between upper portions of these jamb portions 4. An inner space surrounded with this gate frame 3 is a doorway 6.

A header case 7 extending in a horizontal direction is attached to an upper portion of a front face of the building wall 1 on an elevator shaft side by a back angle. A door rail 8 is horizontally hanged in this header case 7. A doorsill 9 is attached to a lower portion of the gate frame 3. This doorsill 9 is horizontally supported to protrude on an elevator shaft side and extend in the lateral direction.

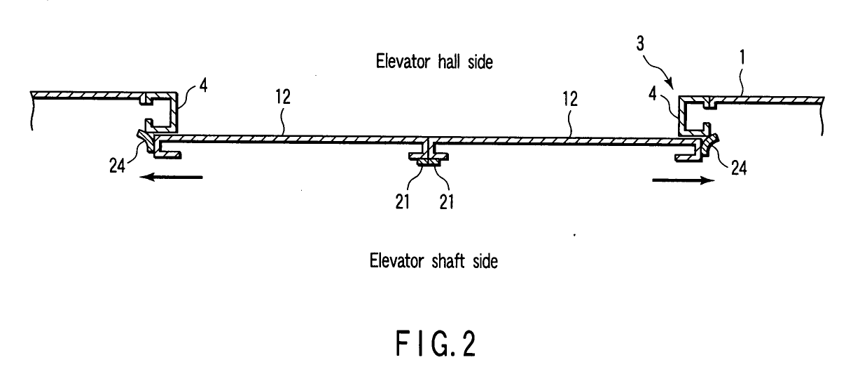

As shown in FIG. 2, a pair of door panels 12 of a biparting door type is provided as a door device facing the gate frame 3 on the elevator shaft side of the gate frame 3. As shown in FIG. 1, headers 13 are attached to upper portions of the door panels 12, respectively. Door rollers 14 are rotatably assembled in these headers 13. The door rollers 14 are rotatably hooked on the door rail 8. Accordingly, the door panels 12 move along the door rail 8 to the left and the right, respectively, to open and close the doorway 6.

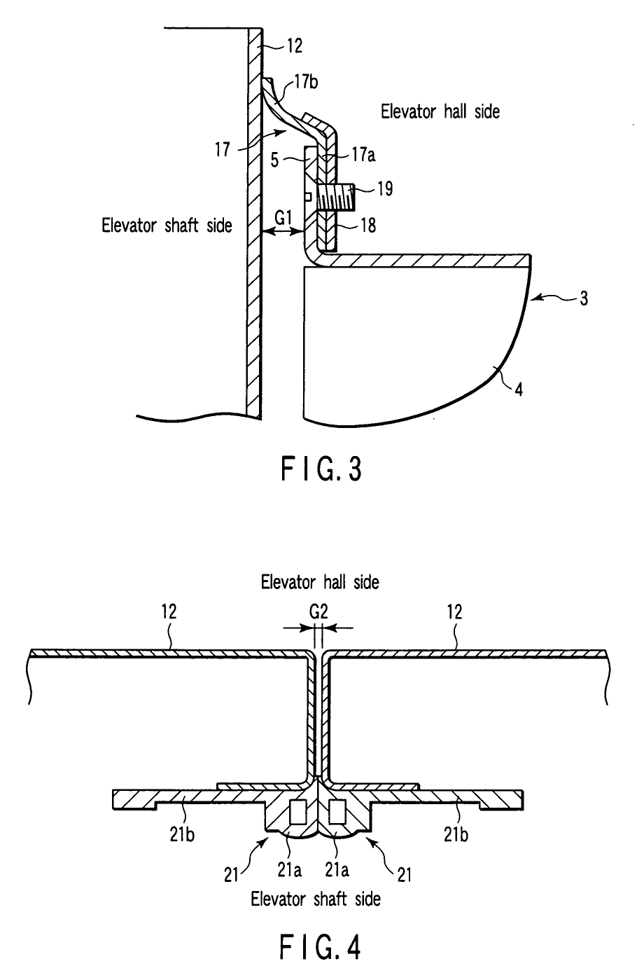

FIG. 3 shows a sectional view, which is a sectional view cut along the B-B line of FIG. 1, of facing portions between the upper portion of the door panel 12 and the header panel portion 5 of the gate frame 3. As shown in FIG. 3, a small gap G1 is provided between the upper portion of each door panel 12 and the header panel portion 5 of the gate frame 3. The sealing member 17 made of an elastic material such as a rubber is provided on the header panel portion 5 to seal the gap G1.

This sealing member 17 has a base portion 17a and a lip portion 17b. A press plate 18 made of a metal is bonded to the base portion 17a with glue. In this state, the base portion 17a is fixed to an inner face of the header panel portion 5 unity with the press plate 18 by a screw 19 as a fastening member.

The sealing members 17 are continuously arranged over substantially the whole length section in the horizontal direction of the header panel portion 5, and fixed to the header panel portion 5 every certain pitch by the screw 19. Each screw 19 is inserted from the center of the elevator shaft into the header panel portion 5. An upper portion of the sealing member 17 constitutes the lip portion 17b obliquely extending upwards from the base portion 17a. While this lip portion 17b keeps an inclined posture with respect to the surface of the door panel 12, a distal-end edge portion of the lip portion is curved to warp as arc, and elastically comes into contact with the surface of the door panel 12. As a result, the gap G1 between the door panel 12 and the header panel portion 5 is airtightly sealed. It is to be noted that when the door panel 12 moves to the left and the right to open or close the doorway, the lip portion 17b of the sealing member 17 slips along the door panel 12.

As shown in FIG. 4, which is sectional view cut along the C-C line of FIG. 1, a pair of door panels 12 of the biparting door type have such a positional relation that side edge portions of the door panels on one side abut on each other. Sealing members are attached to the side edge portions of both of the door panels 12 to seal a gap G2 between doorstop portions.

These sealing members 21 are made of an elastic material such as vinyl chloride. The sealing members 21 are continuously arranged over substantially the whole length section of the door panels 12 in a vertical direction, and fixed to the side edge portions of the door panels 12 by screws or the like.

Each of these sealing members 21 has a hollow comparatively-soft fitting portion 21a, and a base portion 21b extending externally and unity from the fitting portion 21a. The fitting portions 21a come into contact with each other to thereby airtightly seal a gap between doorstop portions of one door panel 12 and the other door panel 12. It is to be noted that when the door panels 12 move in door open directions, a pair of sealing members 21 are separated from each other. The sealing members 21 also function as cushion members to absorb door abutting shock and noise generated at a time when the door panels 12 are closed.

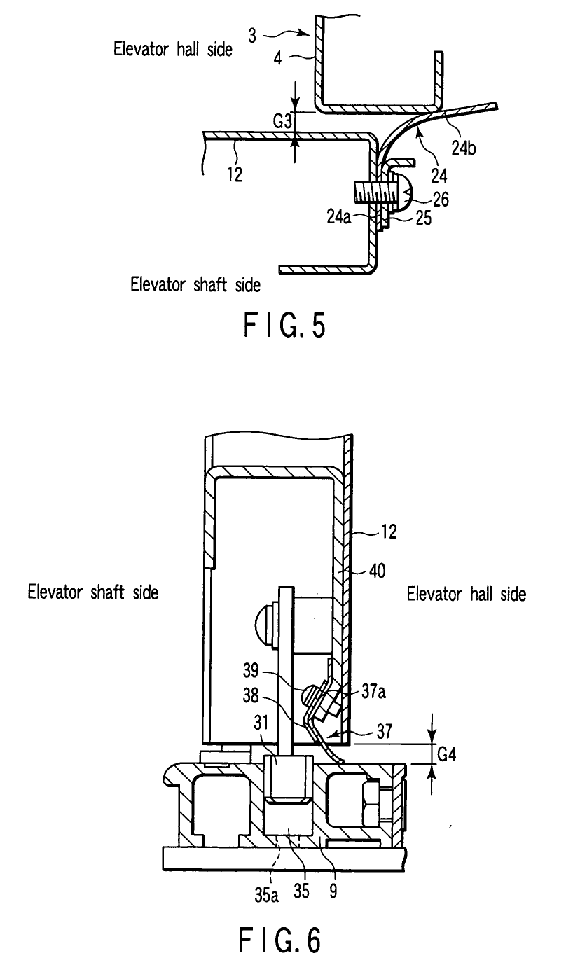

As shown in FIG. 5, which is sectional view cut along the D-D line of FIG. 1, the side edge portion of each door panel 12 on a side opposite to a doorstop has a small gap G3 from the jamb portion 4 of the gate frame 3. The sealing member 24 is made of an elastic material such as a rubber, and attached on an end face of the side edge portion of the door panel 12 to seal this gap G3.

This sealing member 24 has a base portion 24a and a lip portion 24b. A press plate 25 made of a metal is bonded to the base portion 24a with glue. In this state, the base portion 24a is fixed to the end face of the door panel 12 unity with the press plate 25 by a screw 26 as a fastening member. The sealing member 24 is continuously provided substantially over the whole length section of the door panel 12 in the vertical direction, and fixed to the door panel 12 every certain pitch by the screw 26. A side edge of the sealing member 24 constitutes the lip portion 24b extending from the base portion 24a toward the gate frame 3 on a side provided with the jamb portion 4. While this lip portion 24b keeps an inclined posture with respect to the surface of the jamb portion 4, the sealing member 24 is curved to warp as arc so that a side face of an intermediate portion of the lip portion 24b elastically comes into contact with a corner portion of the jamb portion 4. As a result, the gap G3 between the door panel 12 and the jamb portion 4 is airtightly sealed.

The lip portion 24b is left from the jamb portion 4, when the door panel 12 moves in the door open direction. When the door panel 12 moves in a door close direction and is closed, the lip portion 24b comes into contact with the corner portion of the jamb portion 4 to seal the gap G3.

As shown in FIG. 6, which is sectional view cut along the E-E line of FIG. 1, a guide shoe 31 is attached to a lower portion of each door panel 12. As shown in FIG. 1, a pair of guide shoes 31 is provided on each side in the door panel 12. The guide shoes 31 are attached to protrude downwards from the lower end portions of the door panels 12, respectively.

As shown in FIG. 6, a guide groove 35 is formed in a top of the doorsill 9 placed under the gate frame 3 and along a longitudinal direction of the doorsill. The guide shoe 31 is slidably inserted into the guide groove 35. Each door panel 12 moves to open or close the doorway toward the left and the right along the guide groove 35. A drain hole 35a for dropping off rubbish such as wastes is formed in a bottom of the guide groove 35.

A small gap G4 is provided between a lower portion of each door panel 12 and the top of the doorsill 9. The sealing member 37 made of an elastic material such as a rubber is attached on each door panel 12 to seal the gap G4.

This sealing member 37 has a base portion 37a and a lip portion 37b. A press plate 38 made of a metal is bonded to the base portion 37a with glue. In this state, the base portion 37a is fixed to a lower beam 40 arranged on an inside of the door panel 12 unity with the press plate 38. The sealing members 37 are continuously arranged substantially over the whole length section of the door panel 12 in the horizontal direction, and fixed to the lower beams 40 of the door panels 12 every certain pitch by screws 39. Each screw 39 is inserted from the center of the elevator shaft into the lower beam 40 of the door panel 12.

A lower portion of this sealing member 37 constitutes the lip portion 37b extending obliquely downwards from the base portion 37a. While this lip portion 37b keeps an inclined posture with respect to the top of the doorsill 9, a distal-end edge portion of the lip portion is curved to warp as arc, and elastically comes into contact with the top of the doorsill 9. As a result, the gap G4 between the door panel 12 and the doorsill 9 is airtightly sealed. In a case where the door panel 12 moves to the left and the right to open or close the doorway, the lip portion 37b slips along the top of the doorsill 9.

The top of the doorsill 9 is divided in an elevator shaft side and an elevator hall side by the guide groove 35. The lip portion 37b of the sealing member 37 is placed on the elevator hall side from the guide groove 35, and comes into contact with the top of the doorsill 9. As a result, the gap G4 between the door panel 12 and the doorsill 9 is airtightly sealed.

In such constitution, when the door panels 12 are closed, the sealing members 17, 21, 24, and 37 seal the gap G1 between each door panel 12 and the header panel portion 5 of the gate frame 3, the gap G2 between each door panel 12 and the jamb portion 4 of the gate frame 3, the gap G3 between the doorstop portions of both of the door panels 12, and the gap G4 between each door panel 12 and the doorsill 9, respectively. Hence, a flow of air from the elevator hall into the elevator shaft is shut off. Even if a fire is happened on the floor provided with the door panels 12, smoke by the fire does not penetrate the elevator shaft from the elevator hall. Therefore, the hall door apparatus prevents the elevator shaft from being worked as a chimney, and then the spread of fire is inhibited. The smoke can be prevented from being diffused to another floor.

As shown in FIG. 6, the drain hole 35a for dropping off rubbishes is formed in the bottom of the guide groove 35 provided on the doorsill 9. Since the sealing member 37 comes into contact with the top of the doorsill 9 between the elevator hall and the guide groove 35 to seal the gap G4, the smoke on the elevator hall side does not pass into the elevator shaft through the drain hole 35a.

In the hall door apparatus of the present invention, the sealing members 17, 21, 24, and 37 made of the elastic material are simply attached between the door panel 12 and the gate frame 3, between the door panel 12 and doorsill 9, or between in the doorstop portions of the door panels 12. Therefore, the structure can be simply and inexpensively manufactured.

The conventional hall door apparatus using a screen takes an operation time for developing the screen from its stored state at a time of emergency such as fire-accident, whereas such operation time is not required for the hall door apparatus according to the present invention. When the door panels 12 are closed at the emergency, the hall door apparatus can precisely prevents smoke from penetrating into the elevator shaft. In this hall door apparatus, when the sealing members 17, 21, 24, and 37 are simply attached in the gaps between the door panel 12 and the gate frame 3, between the door panel 12 and the doorsill 9, or between on the doorstop portions of the door panels 12, the sealing members 17, 21, 24, and 37 are prevented from being exposed to the side of the elevator hall. Therefore, beautiful appearance of the elevator hall is not marred.

As to the sealing member 17 which seals the gap G1 between the door panel 12 and the header panel portion 5, as shown in FIG. 3, while the lip portion 17b keeps its inclined position against to the surface of the door panel 12, the distal-end edge portion of the lip portion 17b is curved to warp as arc, and elastically comes into contact with the door panel 12. Therefore, the gap G1 is securely sealed. Even when the distal-end edge portion of the lip portion 17b is worn, the portion can appropriately maintain its contact state with the door panel 12. Therefore, the sealing member 17 sufficiently bears its long-term use.

The press plate 18 is attached beforehand to the base portion 17a of the sealing member 17 with the glue. In this state, the base portion 17a is fixed to the header panel portion 5 with the screw 19. The base portion 17a can be stably attached to the header panel portion 5, because the base portion 17a is reinforced by the press plate 18, and is prevented from being unnecessary deformed. The screw 19, which fixes the base portion 17a to the header panel portion 5, is inserted from the center of the elevator shaft into the header panel portion 5. Therefore, the insertion operation can be easily performed. The sealing member 17 is attached to the header panel portion 5 with good efficiency.

As to the sealing member 24 which seals the gap G3 between the side edge portion of the door panel 12 and the jamb portion 4 of the gate frame 3, as shown in FIG. 5, while the lip portion 24b keeps its inclined state against the surface of the jamb portion 4, the intermediate portion of the sealing member 24 is curved to warp as arc, and elastically comes into contact with the corner portion of the jamb portion 4. Therefore, the gap G3 is securely sealed.

The press plate 25 is attached beforehand to the base portion 24a of the sealing member 24 with the glue. In this state, the base portion 24a is fixed to the end face of the door panel 12 by the screw 26. The base portion 24a can be stably attached to the end face of the door panel 12, because the base portion 24a is reinforced by the press plate 25, and is prevented from being unnecessary deformed.

As to the sealing member 37 which seals the gap G4 between the door panel 12 and the doorsill 9, as shown in FIG. 6, while the lip portion 37b keeps its inclined state against the top of the doorsill 9, the distal-end edge portion of the lip portion 37b is curved to warp as arc, and elastically comes into contact with the top of the doorsill 9. Hence, the gap G4 is securely sealed. Even when the distal-end edge portion of the lip portion 37b is worn, the portion can appropriately maintain its contact state with the doorsill 9. Therefore, the sealing member 37 sufficiently bears even its long-term use.

The press plate 38 is attached beforehand to the base portion 37a of the sealing member 37 with the glue. In this state, the base portion 37a is fixed to the lower beam 40 of the door panel 12 by the screw 39. The base portion can be stably fixed to the lower beam 40 of the door panel 12, because the base portion 37a is reinforced by the press plate 38, and is prevented from being uselessly deformed. The screw 39, which fixes the base portion 37a to the lower beam 40 of the door panel 12, is inserted from the center of the elevator shaft into the lower beam 40. Thus, the insertion operation can be easily performed. The sealing member 37 can be attached to the lower beam 40 of the door panel 12 with good efficiency.

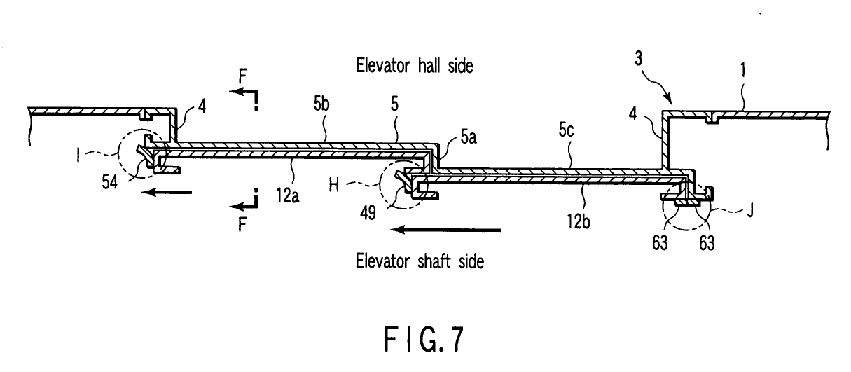

A second embodiment of the present invention will be described with reference to FIGS. 7 to 15. In the above first embodiment, there has been described an example of the door device of the biparting door type in which a pair of door panels 12 are aligned on the same vertical plane. In the door device of the biparting door type, the pair of door panels 12 moves in directions opposite to each other to open or close a doorway. In the second embodiment, as shown in FIG. 7, there will be described an example of a door device of a one side gathering-door type in which a pair of door panels 12a, 12b are arranged in parallel forwards and backwards as viewed from the side of the elevator hall. In the door device of the one side gathering-door type, the pair of door panels 12a, 12b move at different speeds in the same direction to open or close the doorway.

In this second embodiment, the pair of door panels 12a, 12b are arranged in parallel forwards and backwards. Therefore, as shown in FIG. 7, an header panel portion 5 of a gate frame 3 accordingly has a stepped portion 5a in its intermediate portion in a lateral direction, and is formed unevenly. That is, the header panel portion 5 is divided from the stepped portion 5a into a front section 5b on the left side and a rear section 5c on the right side.

In a closed state of this door device shown in FIG. 7, the door panel 12a closer to a destination moves at a low speed, and the door panel 12b distant from the destination moves at a high speed. In FIG. 7, a doorway becomes an opened state when the door panels 12a, 12b move to the left, and the doorway becomes a closed state when the door panels 12a, 12b move to the right.

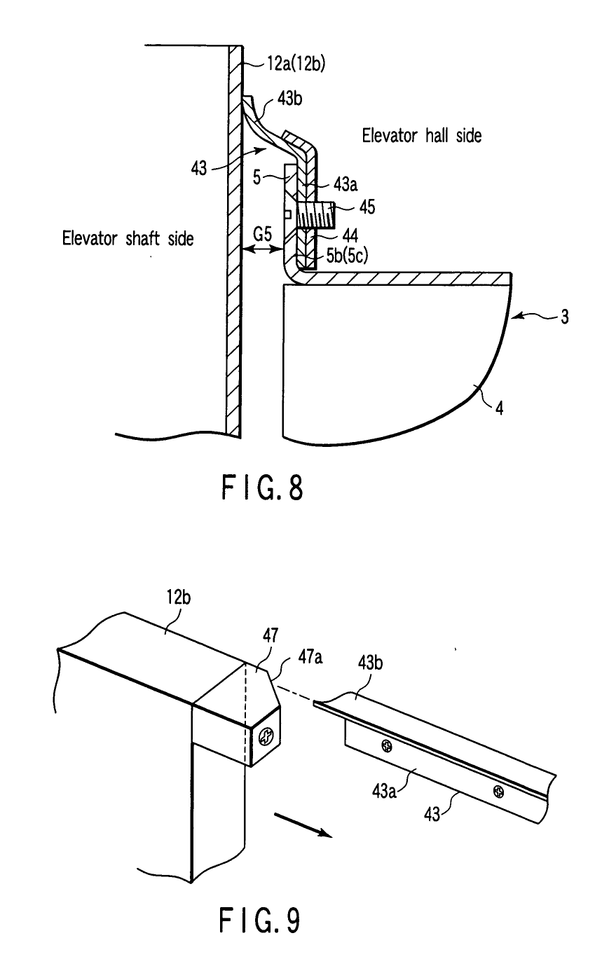

There are narrow gaps G5 between Upper portions of the door panels 12a, 12b and the header panel portion 5 of the gate frame 3 at the front section 5b and the rear section 5c, respectively, as shown in FIG. 8. The front section 5b and the rear section 5c of the header panel portion 5 are equipped with a sealing member 43, which is made of an elastic material such as a rubber, for sealing each gap G5.

Each sealing member 43 has a base portion 43a and a lip portion 43b. A press plate 44 made of a metal is bonded to this base portion 43a with glue. In this state, the base portion 43a is fixed to an inner face of the header panel portion 5 unity with the press plate 44 by a screw 45 as a fastening member. The sealing member 43 attached in the front section 5b of the header panel portion 5 is continuously arranged substantially over the whole length of the front section 5b, and fixed to the header panel portion 5 every certain pitch by the screws 45. The sealing member 43 attached in the rear section 5c of the header panel portion 5 is continuously arranged substantially over the whole length of the rear section 5c, and fixed to the header panel portion 5 every certain pitch by the screws 45. Each screw 45 is inserted from the center of the elevator shaft into the header panel portion 5.

An upper portion of each sealing member 43 constitutes the lip portion 43b extending obliquely upwards from the base portion 43a. While this lip portion 43b keeps its posture leaning toward the surfaces of the door panels 12a, 12b, a distal-end edge portion of the lip portion 43b is curved to warp as arc, and elastically comes into contact with the surfaces of the door panels 12a, 12b. As a result, the gaps G5 between the door panels 12a, 12b and the header panel portion 5 are airtightly sealed.

In FIG. 7, the door panel 12b is detached from the sealing member 43 when the door panel 12b moves beyond the center of the doorway to the left. When the door panel 12b moves to the right to almost reach the center of the doorway, the door panel comes into contact with the sealing member 43 again. As shown in FIG. 9, a guide member 47 is attached to an end face of the door panel 12b so that the door panel 12b smoothly comes into contact with the sealing member 43.

This guide member 47 has a tapered surface 47a. The tapered surface 47a abuts on an edge portion of the lip portion 43b of the sealing member 43, when the door panel 12b moves to the right to close the doorway. As a result, the lip portion 43b is guided to smoothly come into contact with the surface of the door panel 12b. When the door panel 12b is closed, the gap G5 between the door panel 12b and the header panel portion 5 is precisely sealed.

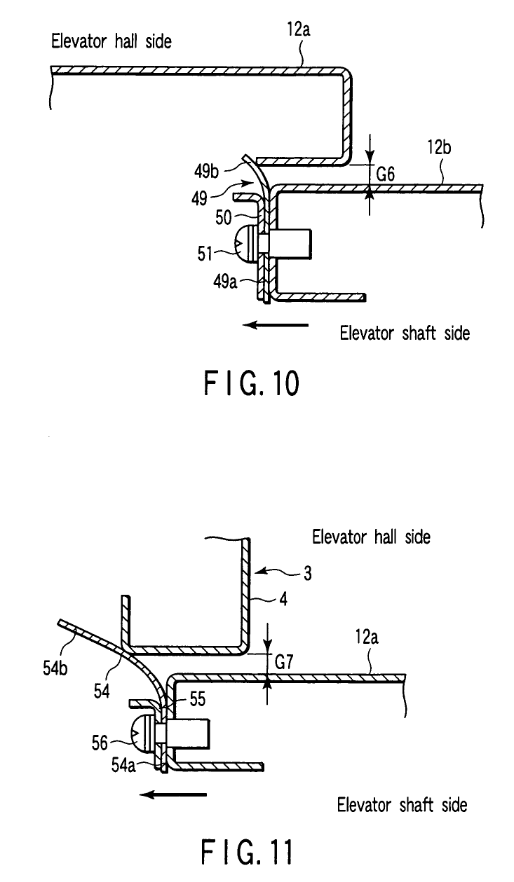

In the one side sliding door type, in a state in which the pair of door panels 12a, 12b are closed, side edge portions of the panels on one side overlap with each other forwards and backwards remaining a gap G6 between the overlapped portions as shown in FIG. 10. A sealing member 49 made of an elastic material such as a rubber is attached to an end face of the door panel 12b to seal the gap G6.

This sealing member 49 has a base portion 49a and a lip portion 49b. A press plate 50 made of a metal is bonded to the base portion 49a with glue. In this state, the base portion 49a is fixed to the end face of the door panel 12b unity with the press plate 50 by a screw 51 as a fastening member. The sealing member 49 is continuously attached substantially over the whole length of the door panel 12b in a vertical direction, and fixed to the door panel 12b every constant pitch by the screws 51.

A side edge portion of the sealing member 49 constitutes the lip portion 49b extending from the base portion 49a toward a side on which the door panel 12a is arranged. While the lip portion 49b keeps its leaning posture toward the surface of the side edge portion of the door panel 12a, the lip portion 49b is curved to warp as arc, and a side face of an intermediate portion of the lip portion 49b comes into contact with a panel edge of the door panel 12a. As a result, the gap G6 between the side edge portions of the door panels 12a, 12b is airtightly sealed.

In a case where the door panels 12a, 12b move in a door closing direction, since there is a difference between movement speeds, the lip portion 49b of the sealing member 49 attached in the door panel 12b is left from a panel edge of the door panel 12a. When the door panels 12a, 12b move in the door closing direction, and are completely closed, the lip portion 49b comes into contact with the panel edge of the door panel 12a to seal the gap G6.

As shown in FIG. 11, a narrow gap G7 is provided between the other side edge portion of the door panel 12a and a jamb portion 4 of the gate frame 3. A sealing member 54 made of an elastic material such as a rubber is attached on the end face of the side edge portion of the door panel 12a to seal the gap G7. The sealing member 54 has a base portion 54a and a lip portion 54b. A press plate 55 made of a metal is bonded to the base portion 54a with glue. In this state, the base portion 54a is fixed to the end face of the door panel 12a unity with the press plate 55 by a screw 56 as a fastening member. This sealing member 54 is continuously provided substantially over the whole length of the door panel 12a in the vertical direction, and fixed to the door panel 12a every constant pitch by screws 56.

One side edge portion of this sealing member 54 constitutes the lip portion 54b extending from the base portion 54a toward a side where the jamb portion 4 of the gate frame 3 is arranged. While lip portion 54b keeps its posture leaning toward the surface of the jamb portion 4 in the gate frame 3, the lip portion 54b is curved to warp as arc, and a side face of an intermediate portion of the lip portion 54b comes into contact with a corner portion of the jamb portion 4. As a result, the gap G7 between the door panel 12a and the jamb portion 4 is airtightly sealed.

The lip portion 54b of the sealing member 54 is left from the jamb portion 4 of the gate frame 3 when the door panel 12a moves in an opened direction. When the door panel 12a moves to completely close the door, the lip portion 54b of the sealing member 54 comes into contact with the corner portion of the jamb portion 4, and seals the gap G7.

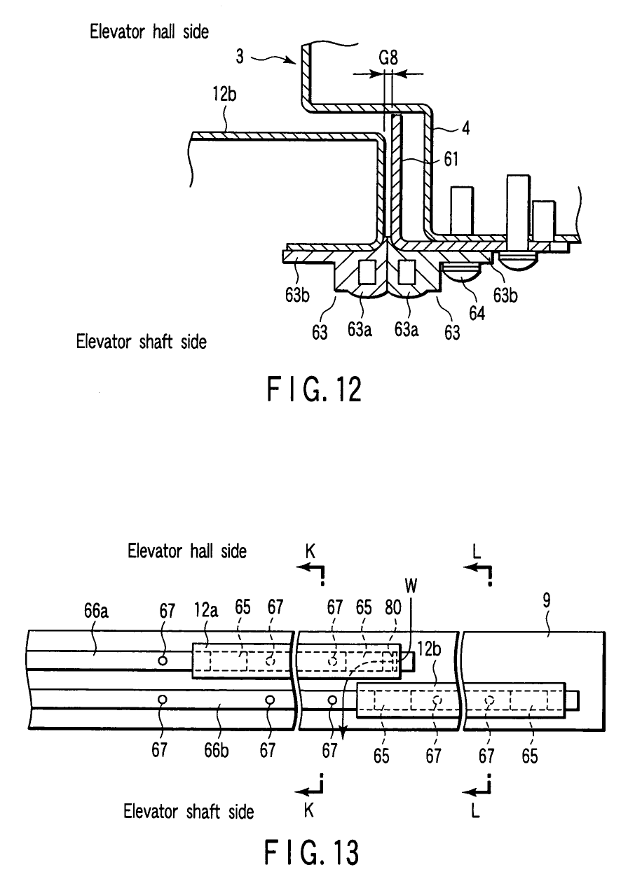

The jamb portion 4 of the gate frame 3 on the right side shown in FIG. 7 is a doorstop portion on which a side edge portion of the door panel 12b abuts. The doorstop portion is provided with a doorstop plate 61 as shown in FIG. 12. The side edge portion of the door panel 12b abuts on the doorstop plate 61 when the door panel 12b is closed. Sealing members 63 are attached to the door panel 12b and the doorstop plate 61, respectively, to seal a gap G8 between the doorstop portions.

These sealing members 63 are made of an elastic material such as vinyl chloride. One sealing member 63 is continuously provided substantially over the whole section of the door panel 12b in the vertical direction, and fixed to the door panel 12b by a screw or the like. The other sealing member 63 is continuously provided substantially over the whole section of the doorstop plate 61 in the vertical direction, and fixed to the doorstop plate 61 with glue and a bolt 64.

These sealing members 63 have hollow comparatively soft fitting portions 63a and base portions 63b extending externally and unity from these fitting portions 63a. The fitting portions 63a are brought into contact with each other to airtightly seal the gap G8. The sealing members 63 also function as cushion members, which absorb shocks or noises that are generated at when the door panel 12b hits the doorstop plate 61.

FIG. 13 shows a plan view of a doorsill 9. The door panels 12a, 12b are set on this doorsill 9 so that the door panels 12a, 12b are displaced forwards and backwards to uneven parallel positions as viewed from the elevator hall. Guide shoes 65 are attached to lower portions of the door panels 12a, 12b, respectively. A pair of guide shoes 65 are arranged on opposite sides of each of the door panels 12a, 12b, and the guide shoes 65 protrude downwards from lower end portions of the door panels 12a, 12b, respectively.

In an upper portion of the doorsill 9, a first guide groove 66a into which the guide shoes 65 of one door panel 12a are fitted, and a second guide groove 66b into which the guide shoes 65 of the other door panel 12b are fitted, are formed along a longitudinal direction of the doorsill 9. Drain holes 67 for dropping off rubbishes such as dust are formed in bottoms of the guide grooves, 66a, 66b, respectively.

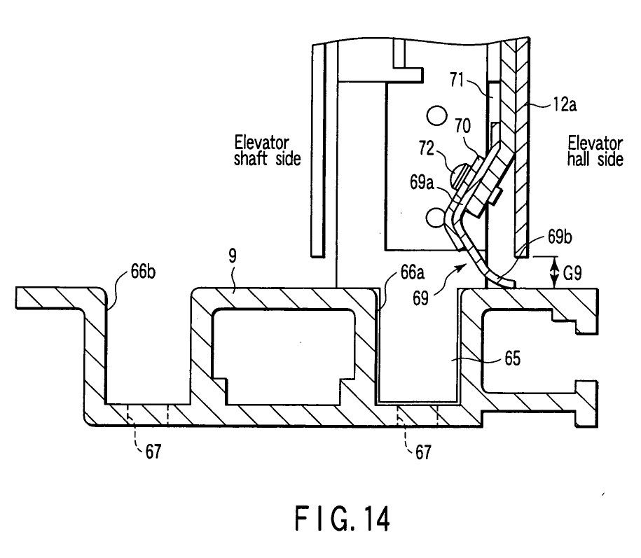

As shown in FIG. 14, a narrow gap G9 is provided between a lower portion of the door panel 12a and a top of the doorsill 9. A sealing member 69 made of an elastic material such as a rubber is attached in the door panel 12a to seal the gap G9.

This sealing member 69 has a base portion 69a and a lip portion 69b. A press plate 70 made of a metal is bonded to the base portion 69a with glue. In this state, the base portion 69a is fastened to a lower beam 71 provided on an inside surface of the door panel 12a unity with the press plate 70 by a screw 72 as a fastening member. The sealing member 69 is continuously provided substantially over the whole length of the door panel 12a in the lateral direction, and fixed to the lower beam 71 of the door panels 12a every constant pitch by the screws 72. Each screw 72 is inserted from the inside of the elevator shaft into the lower beam 71 of the door panel 12a.

A lower portion of this sealing member 69 constitutes the lip portion 69b extending obliquely downwards from the base portion 69a. While this lip portion 69b keeps its posture leaning toward the top of the doorsill 9, a distal-end edge portion of the lip portion 69b is curved to warp as an arc, and elastically comes into contact with the upper portion of the doorsill 9.

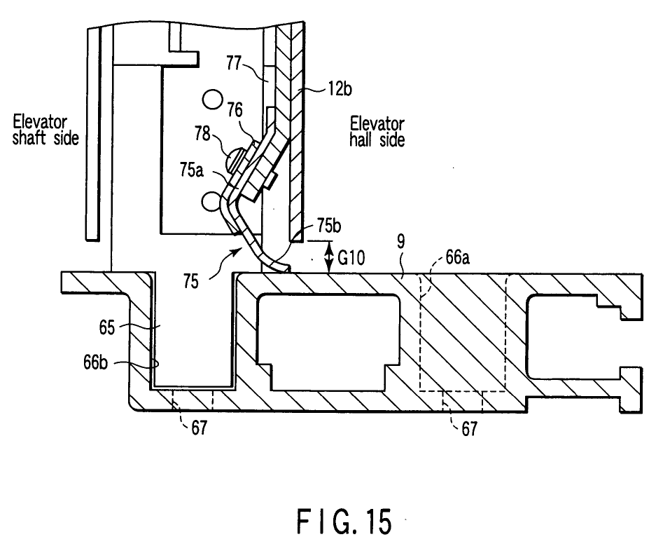

A position, where the lip portion 69b of the sealing member 69 comes into contact with the top of the doorsill 9, is closer to the elevator hall side than to the guide groove 66a formed in the doorsill 9. As shown in FIG. 15, a narrow gap G10 is made between the lower portion of the door panel 12b and the top of the doorsill 9. The door panel 12b is attached on a sealing member 75 made of an elastic material such as a rubber in order to seal the gap G10.

This sealing member 75 has a base portion 75a and a lip portion 75b. A press plate 76 made of a metal is bonded to the base portion 75a with glue. In this state, the base portion 75a is fastened to a lower beam 77 arranged on an inside surface of the door panel 12b unity with the press plate 76 by a screw 78 as a fastening member. This sealing member 75 is continuously provided substantially over the whole length of the door panel 12b in the lateral direction, and fixed to the lower beam 77 of the door panels 12b every constant pitch by the screws 78. Each screw 78 is inserted from the internal side of the elevator shaft into the lower beam 77 of the door panel 12b.

A lower portion of this sealing member 75 constitutes the lip portion 75b extending obliquely downwards from the base portion 75a. While this lip portion 75b keeps its posture leaning toward the top of the doorsill 9, a distal-end edge portion of the lip portion 75b is elastically brought into contact with the top of the doorsill 9. A position where the lip portion 75b comes into contact with the top of the doorsill 9 is closer to the elevator hall side than to the guide groove 66b formed in the doorsill 9.

Since the guide groove 66a is formed in the top of the doorsill 9, a path is created from the elevator hall side toward the elevator shaft side through the first guide groove 66a as shown by an arrow W in FIG. 13. A sealing member 80 made of an elastic material such as a rubber is attached to a lower end face of a side edge portion of the door panel 12a. A lower portion of the sealing member 80 is inserted into the guide groove 66a to shut off the path which connects the elevator hall side to the elevator shaft side.

In such constitution, the sealing members 43, 49, 54, 63, 69, and 75 seal the gap G5 between each of the door panels 12a, 12b and the header panel portion 5 of the gate frame 3, the gap G6 between the opposite door panels 12a, 12b, the gap G7 between the door panel 12a and one jamb portion 4 of the gate frame 3, the gap G8 between the door panel 12b and the doorstop portion of the other jamb portion 4 of the gate frame 3, and the gaps G9, G10 between the door panels 12a, 12b and the doorsill 9, respectively. Hence the flow of air from the elevator hall into the elevator shaft side is shut. Even when an emergency such as a fire-accident happens on a floor provided with a door device, smoke caused by the fire does not enter the elevator shaft from the elevator hall, because, the hall door apparatus prevents the elevator shaft from being functioned as a chimney, and can avoid the fire developing. The hall door apparatus can also prevent the smoke from being diffused to another floor.

The drain holes 67 for dropping off the rubbishes are opened in the bottoms of the guide grooves 66a, 66b formed in the doorsill 9. The sealing members 69, 75 are displaced toward the elevator hall side rather than the guide grooves, 66a, 66b, and come into contact with the top of the doorsill 9. Therefore, the smoke on the elevator hall side does not flow into the elevator shaft through the discharge holes 67. Since the sealing member 80 shuts off the path shown by the arrow W in FIG. 13, the smoke on the elevator hall side does not leak in the elevator shaft.

As to the sealing members 43 which seal the gaps G5 between the door panels 12a, 12b and the header panel portion 5, as shown in FIG. 8, while the lip portions 43b keep states leaning toward the surfaces of the door panels 12a, 12b, the distal-end edge portions of the lip portions 43b are curved to warp as an arc, and elastically come into contact with the surfaces of the door panels 12a, 12b. Therefore, the gaps G5 are securely sealed. The distal-end edge portion of the lip portion 43b can appropriately maintain its contact state with each of the door panels 12a, 12b, even when the distal-end edge portion is worn, thus the sealing member sufficiently bears its long-term use.

The press plate 44 is attached beforehand to the base portion 43a of the sealing member 43 with the glue. In this state, the base portion 43a is fixed to the header panel portion 5 with the screw 45, and reinforced by the press plate 44. Therefore, the base portion 43a is prevented from being unnecessary deformed. Therefore, the sealing member 43 can be stably attached to the header panel portion 5. The screw 45, which fixes the base portion 43a to the header panel portion 5, is inserted from the internal side of the elevator shaft into the header panel portion 5. Therefore, the operation to insert the screw 45 can be easily performed, and the screw 45 is attached to the header panel portion 5 with good efficiency.

As to the sealing member 49 which seals the gap G6 between the overlap portions of the opposite door panels 12a, 12b, as shown in FIG. 10, the lip portion 49b is curved to warp as an arc, and elastically comes into contact with the panel edge of the door panel 12a. Therefore, the gap G6 is securely sealed. The press plate 50 is attached beforehand to the base portion 49a of the sealing member 49 with the glue. In this state, the base portion 49a is fixed to the end face of the door panel 12b by the screw 51, and reinforced by the press plate 50. Therefore, the base portion 49a is prevented from being unnecessary deformed. Hence, the sealing member 49 can be stably attached to the end face of the door panel 12b.

As to the sealing member 54 which seals the gap G7 between the side edge portion of the door panel 12a and the jamb portion 4 of the gate frame 3, as shown in FIG. 11, while the lip portion 54b keeps its state leaning toward the surface of the jamb portion 4, the intermediate portion of the lip portion 54b is curved to warp as an arc, and elastically comes into contact with the corner portion of the jamb portion 4. Therefore, the gap G7 is securely sealed.

The press plate 55 is attached beforehand to the base portion 54a of the sealing member 54 with the glue. In this state, the base portion 54a is fixed to the end face of the door panel 12a by the screw 56, and reinforced by the press plate 55. Therefore, the base portion is prevented from being unnecessary deformed. Hence, the sealing member 54 can be stably attached to the end face of the door panel 12a.

As to the sealing member 69 which seals the gap G9 between the door panel 12a and the doorsill 9, as shown in FIG. 14, while the lip portion 69bs keep its state leaning toward the top of the doorsill 9, the distal-end edge portion of the lip portion 69b is curved to warp as an arc, and elastically comes into contact with the top of the doorsill 9. Therefore, the gap G9 is securely sealed. The distal-end edge portion of the lip portion 69b can appropriately maintain its contact state with the doorsill 9, even when the distal-end edge portion is worn, thus the hall door apparatus sufficiently bears its long-term use.

The press plate 70 is attached beforehand to the base portion 69a of the sealing member 69 with the glue. In this state, the base portion 69a is fixed to the lower beam 71 of the door panel 12a with the screw 72. Therefore, the base portion 69a is prevented from being unnecessary deformed, because the press plate 70 reinforces the base portion 69a. The sealing member 69 can be stably attached to the lower beam 71 of the door panel 12a. The screw 72 which fixes the base portion 69a to the lower beam 71 of the door panel 12a is inserted from the internal side of the elevator shaft into the lower beam 71. This insertion operation can be easily performed. The sealing member 69 can be attached to the lower beam 71 of the door panel 12a with good efficiency.

As to the sealing member 75 which seals the gap G10 between the door panel 12b and the doorsill 9, as shown in FIG. 15, while the lip portion 75b keeps its state leaning toward the top of the doorsill 9, the distal-end edge portion of the lip portion 75b is curved to warp as an arc, and elastically comes into contact with the top of the doorsill 9. Therefore, the gap G10 is securely sealed. The distal-end edge portion of the lip portion 75b can appropriately maintain its contact state with the doorsill 9, even when the distal-end edge portion is worn, thus sufficiently bear its long-term use.

The press plate 76 is attached beforehand to the base portion 75a of the sealing member 75 with the glue. In this state, the base portion 75a is fixed to the lower beam 77 of the door panel 12b by the screw 78 as the fastening member. Therefore, the base portion 75a is prevented from being unnecessary deformed, because the base portion 75a is reinforced by the press plate 76. The sealing member 75 can be stably attached to the lower beam 77 of the door panel 12b. The screw 78 which fixes the base portion 75a to the lower beam 77 of the door panel 12b is inserted from the internal side of the elevator shaft into the lower beam 77. Therefore, the insertion operation is easily performed. The sealing member 75 can be stably attached to the lower beam 77 of the door panel 12b.

It is to be noted that in the second embodiment, there has been described an example of the one-side sliding door type of door device in which two door panels overlap with each other in an uneven parallel state to move in the same direction. The door device may be a door device of a one-side sliding door type which is consisted of three or more door panels overlap with one another in the uneven parallel state to move in the same direction.

The present invention is not limited to the above embodiments, and needless to say, an embodiment of the present invention can be variously modified without departing from the scope. For example, the sealing member may be made of any material as long as the material has elasticity. As the elastic material constituting the sealing member, material is preferably applied which includes silicon rubber, fluorine-based rubber, ethylene propylene rubber (especially, ethylene propylene diene monomer), vinyl chloride (especially soft vinyl chloride) or the like.

The material is selected in consideration of viewpoints such as tensile strength, tear strength, wear resistance, light resistance, manufacturability, slippage, and heat resistance. There will be described characteristics of the materials. The silicon rubber has remarkably satisfactory light resistance, and also has satisfactory manufacturability and heat resistance. The ethylene propylene rubber has remarkably satisfactory light resistance, and also has satisfactory tensile strength, tear strength, and manufacturability. The fluorine-based rubber has remarkably satisfactory tensile strength, wear resistance, light resistance, slippage, and heat resistance, and also has satisfactory tear strength. Vinyl chloride has remarkably satisfactory manufacturability, and also has satisfactory light resistance, heat resistance, and incombustibility.

The present inventors carried out simulation in consideration of these characteristics of the materials. As a result, it has been found that the fluorine-based rubber is preferably used in the sealing members 17, 43, the fluorine-based rubber is preferably used in the sealing members 37, 69, and 75, the ethylene propylene rubber is preferably used in the sealing members 24, 49, and 54, and vinyl chloride is preferably used in the sealing members 21, 63.

A reason why different materials are selected for the respective sealing members is that required conditions differ with the respective sealing members. For example, the sealing members 17, 43, 37, 69, and 75 especially require the wear resistance and slippage. The sealing members 24, 49 especially require manufacturability, wear resistance, and light resistance. The sealing members 21, 63 especially require manufacturability, light resistance, and incombustibility. These sealing members have a thickness which is comparatively thin about 0.1 mm to several millimeters depending on a position where the sealing members are utilized for.

According to such constitution, the sealing member can keep its airtightness more precisely, further has an ease of manufacturing, and also has a long life.

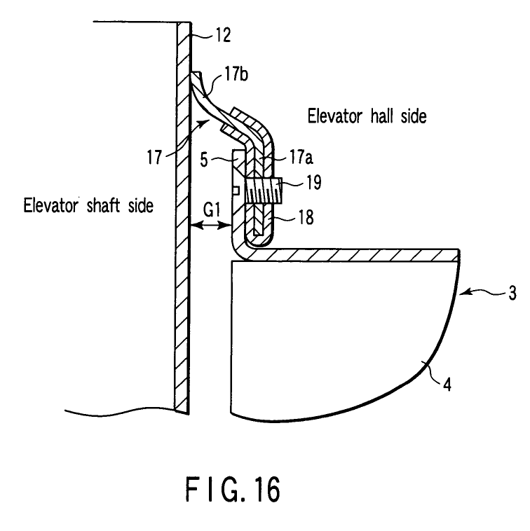

Next, a third embodiment of the present invention will be described with reference to a sectional view of FIG. 16. In this embodiment, a sealing member 17 has a base portion 17a and a lip portion 17b. The base portion 17a is reinforced by being sandwiched between press plate 18 that is made of a metal having a U-shaped vertical section. In this state, the base portion 17a is fixed to an internal surface of an header panel portion 5 unity with the press plate 18 by a screw 19 as a fastening member.

The press plate 18 is made of a stainless steel plate, a carbon steel plate or the like. The press plate 18 has a “<”-shaped vertical section, which is looks like the sign of inequality, such as a “V”-shape. The sealing member 17 is inserted along the “<”-shape, and its posture is held. The sealing member 17 and the press plate 18 are formed into sufficient lengths so that a “<”-shaped portion is arranged above an end portion of the header panel portion 5.

The sealing member 17 is continuously provided substantially over the whole length in a lateral direction of the header panel portion 5, and fixed to the header panel portion 5 every constant pitch by the screws 19. Each screw 19 is inserted from the internal side of the elevator shaft into the header panel portion 5.

An upper portion of the sealing member 17 constitutes the lip portion 17b extending obliquely upwards from the base portion 17a. While this lip portion 17b keeps its posture leaning toward the surface of a door panel 12, a distal-end edge portion of the lip portion 17b is curved to warp as an arc, and elastically comes into contact with the surface of the door panel 12. As a result, a gap G1 between the door panel 12 and the header panel portion 5 is airtightly sealed. In a case where the door panel 12 laterally moves, the lip portion 17b of the sealing member 17 slips along the door panel 12. Since the base portion 17a is sandwiched in the folded portion of the press plate 18, rigidity of the sealing member 17 is improved, and contact strength (holding strength) can further be improved.

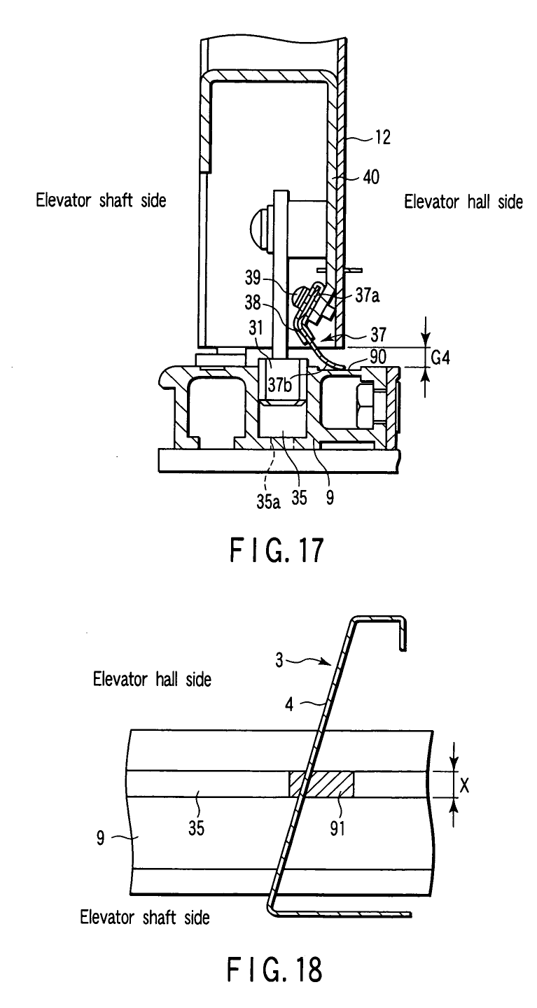

Next, a fourth embodiment of the present invention will be described with reference to a sectional view of FIG. 17. In this embodiment, a sealing member 37 has a base portion 37a and a lip portion 37b. The base portion 37a is reinforced by being sandwiched between a folded portion of the press plate 38 that is made of a metal and has a substantially U-shaped vertical section. In this state, the base portion 37a is fixed to a lower beam 40 arranged on an internal side of a door panel 12 unity with a press plate 38 by a screw 39 as a fastening member. This press plate 38 is made of a stainless steel plate, a carbon steel plate or the like. An end portion of the press plate 38 has a “<”-shaped vertical section, which is looks like the sign of inequality, such as “V”-shape. The sealing member 37 is sandwiched along the “V”-shape in a folded portion of “U”-shaped of the press plate 38, and its posture is held. It is to be noted that the end portion of the press plate 38 is arranged in almost the same position as that of a lower end of the door panel 12.

This sealing member 37 is continuously provided substantially over the whole length in a horizontal direction of the door panel 12, and fastened to the lower beam 40 of the door panel 12 every constant pitch by the screws 39. Each screw 39 is inserted from the internal side of the elevator shaft into the lower beam 40 of the door panel 12. A lower portion of the sealing member 37 constitutes the lip portion 37b extending obliquely downwards from the base portion 37a. While this lip portion 37b keeps its posture leaning toward the top of a doorsill 9, a distal-end edge portion of the lip portion 37b is curved to warp as an arc. The distal-end edge portion of the lip portion 37b elastically comes into contact with a shallow groove-like recessed portion 90 formed in an upper portion of the doorsill 9 along a longitudinal direction. As a result, a gap G4 between the door panel 12 and the doorsill 9 is airtightly sealed. In a case where the door panel 12 moves to the left and the right to open or close the doorway, the lip portion 37b of the sealing member 37 slips along the recessed portion 90 in the upper portion of the doorsill 9.

The top of the doorsill 9 is separated into an elevator shaft side and an elevator hall side by a guide groove 35. The lip portion 37b of the sealing member 37 is displaced toward the elevator hall side rather than the guide groove 35, and comes into contact with the recessed portion 90. Therefore, the gap G4 between the door panel 12 and the doorsill 9 is airtightly sealed by the contact.

According to such constitution, airtightness can be kept more precisely, manufacturing is facilitated, and a life of the sealing member 37 can be lengthened. Since the lip portion 37b is set to come into contact with the recessed portion 90, it is easy to adjust the sealing member 37 during installation.

Next, a fifth embodiment of the present invention will be described with reference to a sectional view of FIG. 18.

A door device provided with a hall door apparatus of this embodiment is of a one-side sliding door type. A plugging member 91 made of an elastic material such as sponge or rubber is fitted into a guide groove 35 in a area, which is a hatched zone in the drawing, where the guide groove crosses/overlaps a jamb portion 4 of a gate frame 3, thus the groove is closed. The plugging member 91 has a substantially rectangular parallelepiped shape in accordance with a shape of the guide groove 35. It is assumed that a width, which is a size in a vertical direction in the drawing, of the plugging member 91 before inserted into the guide groove 35 is larger than a width X of the guide groove 35. It is also assumed that the plugging member 91 has a length of about several millimeters along the guide groove 35 centering on an edge of the gate frame 3. Therefore, after inserting the plugging member 91, one end portion of the plugging member 91 can be viewed.

According to such constitution, air can be prevented from being leaked from the guide groove 35, and airtightness can be improved in the one-side sliding door type door device.

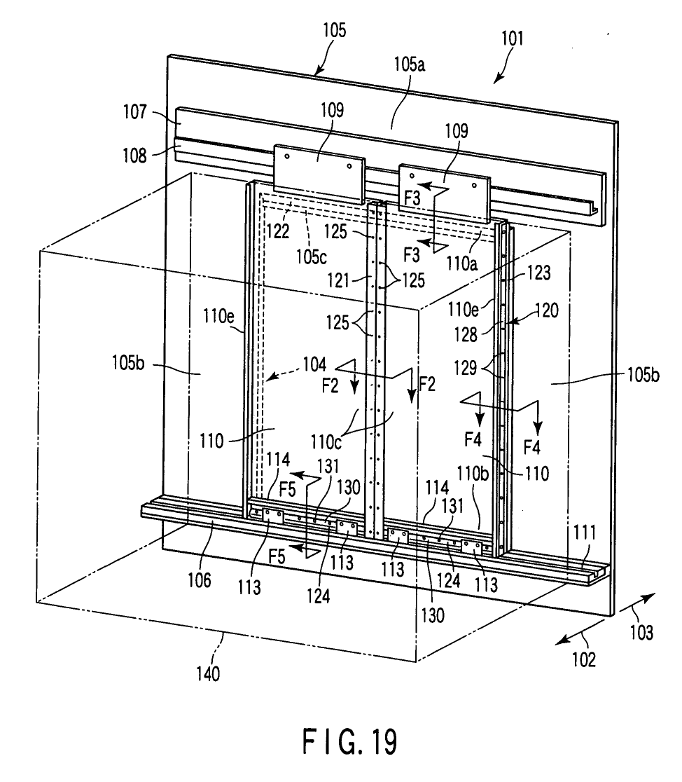

Next, a sixth embodiment of the present invention will be described with reference to FIGS. 19 to 27. First, there will be described a constitution of an elevator 101 provided with a smoke shut-off device.

FIG. 19 shows a perspective view of an entrance port 104 of an elevator which connects an elevator shaft 102 to an elevator hall 103 in a building as viewed from an elevator shaft 102 side. The entrance port 104 is surrounded with a gate frame 105 and a doorsill 106. Both of the gate frame 105 and the doorsill 106 are attached to a wall face of the building from the elevator shaft 102 side.

The gate frame 105 is formed into a gate shape by a header panel portion 105a and jamb portions 105b. The header panel portion 105a is positioned in an upper portion of the entrance port 104, and the jamb portions 105b extend downwards from opposite ends of the header panel portion 105a. A header case 107 is attached to the header panel portion 105a from the elevator shaft 102 side. The header case 107 includes a door rail 108 arranged horizontally. From the door rail 108, there is hung a hall door 110 as an example of a door panel whose upper portion 110a is provided with suspension devices 109. The suspension devices 109 contain a plurality of suspension rollers brought into rolling contact with the door rail 108. The suspension rollers are finely adjustably arranged in a vertical direction and a direction crossing the door rail 108, respectively. Hence a position of the hall door 110 is adjusted by these structures.

The doorsill 106 is arranged in the horizontal direction to connect lower ends of the jamb portions 105b to each other. The doorsill 106 is provided with a groove 111 extending in parallel with the door rail 108. A bottom portion 111a of the groove 111 is provided with several drain holes 112 for dropping off rubbishes such as dust. As shown in FIG. 23, a guide shoe 113 arranged in a lower portion 110b of the hall door 110 slides along opposite sidewalls 111b of the groove 111. Two guide shoes 113 are provided in a movement direction of the hall door 110. The hall door 110 is guided by the door rail 108 and the groove 111, and smoothly moves. It is to be noted that instead of the guide shoes 113, there may be provided guide rollers which individually come into rolling contact with the opposite sidewalls 111b of the groove 111.

Two hall doors 110 are prepared to constitute a biparting door type, and have a size to close the entrance port 104. A smoke shut-off device 120 is assembled into a hall door apparatus between the hall door 110 and the gate frame 105 and doorsill 106. The smoke shut-off device 120 closes a gap remained in a state in which the hall door 110 is closed. The smoke shut-off device 120 includes doorstop shield members 121, a header panel shield member 122, door pocket shield members 123, and doorsill shield members 124.

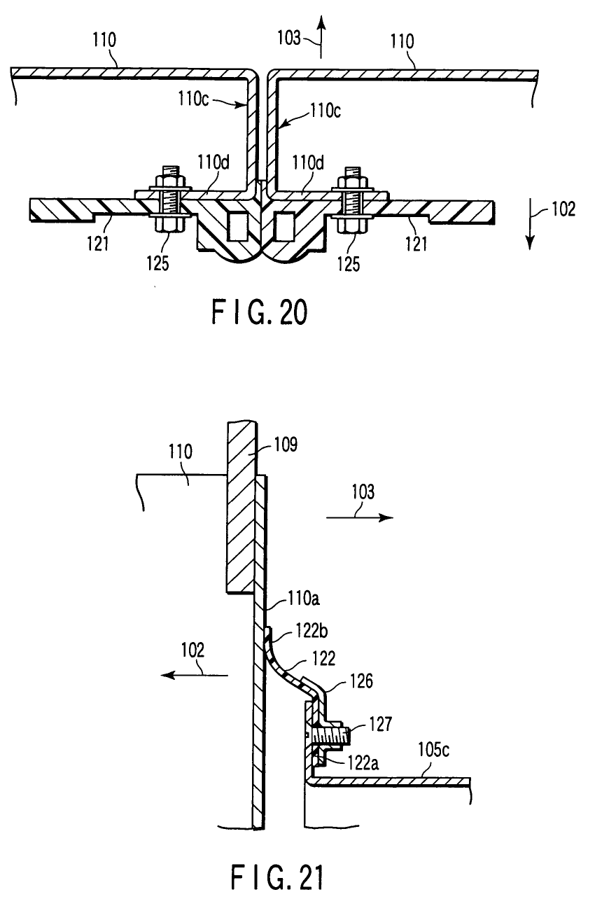

As shown in FIG. 20, the doorstop shield members 121 are attached to doorstop portions 110c on which the hall doors 110 abut. Each doorstop portion 110c of the hall door 110 is folded back to the elevator shaft 102 side, and the doorstop shield members 121 are fixed to folded-back end portions 110d with bolts 125 from the elevator shaft 102 side. The doorstop shield members 121 protrude toward the doorstop portions 110c of the hall doors 110 in movement directions of the hall doors 110, the doorstop shield members 121 are fitted to each other over the whole length in a state in which the hall doors 110 are closed, and then the doorstop shield members 121 seal a gap remained between the hall doors 110. The doorstop shield members 121 are made of a material having flexibility and elasticity, such as vinyl chloride or hard rubber. As the doorstop shield members 121, an incombustible synthetic resin is preferably used. The doorstop shield members 121 also function as cushion members which absorbs shock or noise that are generated at a time when the hall doors 110 are hit each other by closing.

As shown in FIG. 21, a proximal end 122a of the header panel member 122 is sandwiched between a bracket 105c and a press plate 126, and fixed by stop screws 127 screwed from the elevator shaft 102 side. The bracket 105c extends from a lower end of the header panel portion 105a toward the elevator shaft 102. The press plate 126 is folded toward the hall door 110. The header panel shield member 122 extends on the hall door 110 side along the press plate 126. A distal end 122b of the header panel shield member 122 comes into slide contact with an upper portion 110a of the hall door 110. The header panel shield member 122 closes a gap remained between the upper portion 110a of the hall door 110 and the header panel portion 105a in a state in which the hall doors 110 are closed. The header panel shield member 122 is made of a material having flexibility and elasticity, such as a rubber. Since the header panel shield member 122 comes into slide contact with the hall door 110, it is also preferable to use an incombustible synthetic resin in consideration of wear resistance.

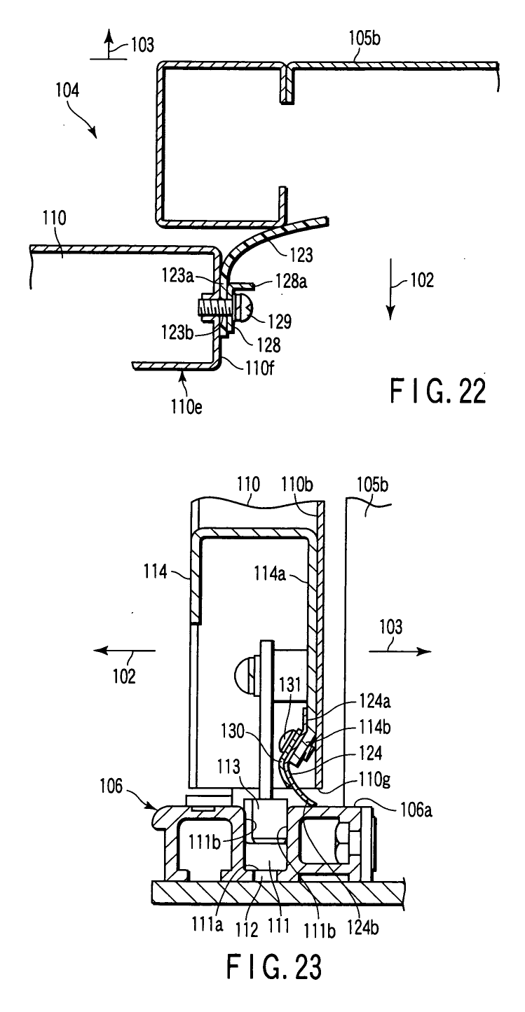

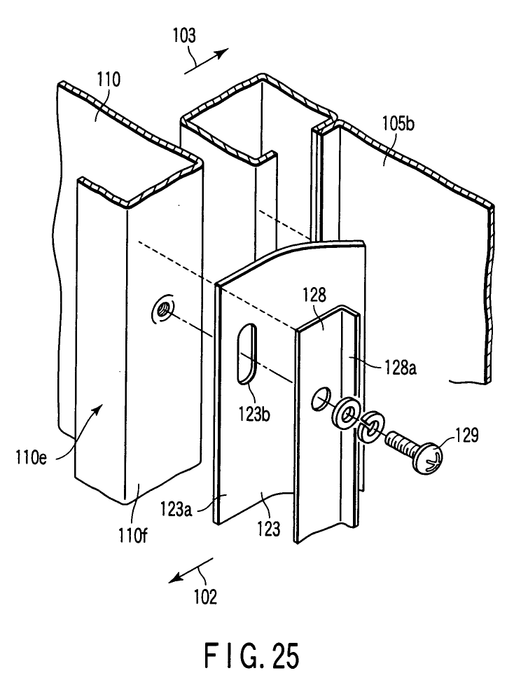

As shown in FIG. 22, the door pocket shield members 123 are attached to door pocket side edge portions 110e of the hall doors 110. Each door pocket side edge portion 110e of the hall door 110 is folded back to the elevator shaft 102 side. A proximal end 123a of the door pocket shield member 123 is fixed by a stop screw 129, being attached a press plate 128, to an end face 10f as a distal end of a travel direction in a case where the hall door 110 is opened. An end portion 128a of the press plate 128 on the gate frame 105 side is folded and raised in a direction left away from the hall door 110. The door pocket shield member 123 comes into contact with the jamb portion 105b of the gate frame 105 in a state in which the hall door 110 is closed, and closes a gap remained between the door pocket side edge portion 110e of the hall door 110 and the jamb portion 105b of the gate frame 105. As shown in FIG. 25, an attachment hole 123b opened in the door pocket shield member 123 is formed into an oval shape which is long along the vertical direction. The door pocket shield member 123 is made of a material having flexibility and elasticity, such as a rubber. When the hall door 110 is opened and closed, the door pocket shield member 123 abuts on the jamb portion 105b of the gate frame 105, and is repeatedly bent. Therefore, it is also preferable to use an incombustible synthetic resin in consideration of wear resistance and restoring force.

As shown in FIG. 23, the doorsill shield member 124 is attached to a lower beam 114 assembled along the lower portion 110b of the hall door 110. The lower beam 114 has a lower edge portion 114b obliquely extending toward the elevator shaft 102 side from a front wall 114a which abuts on the hall door 110. A proximal end 124a of the doorsill shield member 124 is sandwiched between the lower edge portion 114b and a press plate 130, and fixed with a stop screw 131. The press plate 130 is bent toward the hall door 110 side. Therefore, the doorsill shield member 124 is bent back along the press plate 130, and extends toward the elevator hall 103 side. A distal end 124b of the doorsill shield member 124 extends downwards from a lower end 110g of the hall door 110, and comes into slide contact with a top 106a of the doorsill 106 on the elevator hall 103 side over the groove 111. An attachment hole 124c opened the doorsill shield member 124 is formed into an oval shape which is long in a direction extending from the proximal end 124a toward the distal end 124b of the doorsill shield member 124. The doorsill shield member 124 is made of a material having flexibility and elasticity, such as a rubber. Since the doorsill shield member 124 comes into slide contact with the doorsill 106, it is also preferable to use an incombustible synthetic resin in consideration of wear resistance.

The elevator 101 provided with the smoke shut-off device composed as described above is provided with the smoke shut-off device 120 which closes the gaps made between the hall door 110 and the entrance port 104. Since ventilation of the elevator shaft 102 and the elevator hall 103 is shut off, smoke caused by a fire can be prevented from leaking from the elevator hall 103 side into the elevator shaft 102 in a case where the fire-accident is happened. The hall door apparatus avoids the fire spreading, because the hall door apparatus prevents the elevator shaft 102 from being functioned as a chimney. The smoke or gas generated by the fire is prevented from being diffused to another floor.

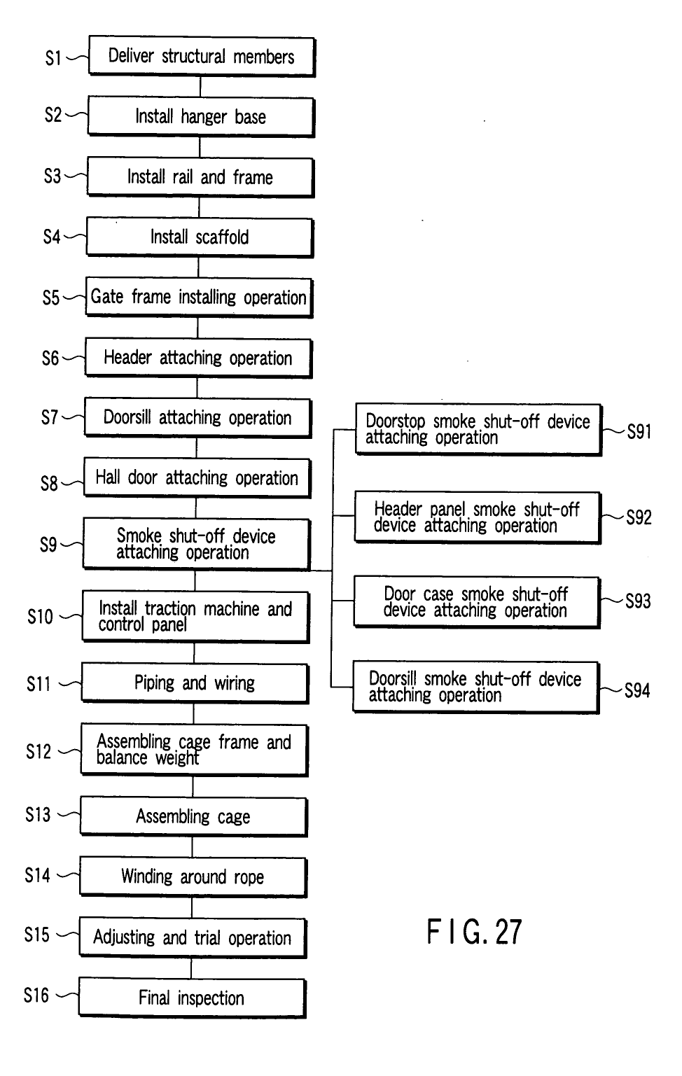

Next, a procedure for assembling the elevator 101, which is provided with the smoke shut-off device composed as described above, will be described with reference to FIG. 27.

In a process for assembling the elevator 101 provided with the smoke shut-off device, first a material is conveyed into the elevator shaft 102 of the building (S1), and a hanger is installed (S2). Next, rails, frames, and the like are attached in order from a lowermost layer (S3). If necessary, a scaffold is prepared in the elevator shaft 102 (S4). When the rails or the frames are assembled up to an uppermost floor, the gate frame is installed (in S5), the header is attached (in S6), the doorsill is attached (in S7), the hall doors are attached (in S8), and the smoke shut-off device is attached (in S9).

In installing the gate frame in S5, the gate frame 105 is assembled from the elevator shaft 102 side. In attaching the header in S6, the header case 107 is attached to the header panel portion 105a that is an upper portion of the gate frame 105. In attaching the doorsill in S7, the doorsill 106 is attached to the lower portion of the gate frame 105, where is the lower end of the jamb portions 105b, from the elevator shaft 102 side. In attaching the hall doors in S8, the hall doors 110 are hung from the door rail 108 provided in the header case 107. At this time, guide shoes 113 are inserted into the groove 111 of the doorsill 106. The suspension devices 109 and the guide shoes 113 are adjusted to finely adjust the position of the hall doors 110.

In attaching the smoke shut-off device in S9, an operation to attach the smoke shut-off device 120 is performed from the elevator shaft 102 side. The attaching operation (in S9) of the smoke shut-off device is more finely divided into an attaching operation (in S91) of a doorstop smoke shut-off device, an attaching operation (in S92) of a header panel smoke shut-off device, an attaching operation (in S93) of a door pocket smoke shut-off device, and an attaching operation (in S94) of a doorsill smoke shut-off device.

In the attaching operation S91, the doorstop smoke shut-off device the doorstop shield members 121 are attached to the doorstop portions 110c on which the hall doors 110 of the biparting door type are mutually abut. It is to be noted that a combination of a pair of hall doors 110 of the biparting door type is predetermined in many cases. Therefore, the attaching operation S91 of the doorstop smoke shut-off device may be performed before the attaching operation S8 of the hall doors. When the attaching operation S91 is performed in a factory before the elevator 101 provided with the smoke shut-off device is shipped from the factory to the building where the elevator is to be installed, an operation at the actual location can be reduced in an elevator installing work.

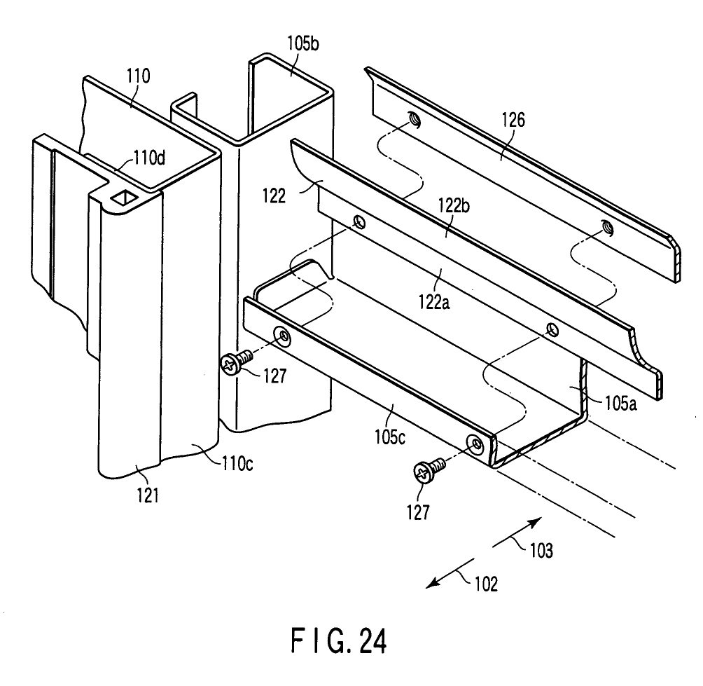

In the attaching operation S92 of the header panel smoke shut-off device, the header panel shield member 122 is attached to the header panel portion 105a under the header case 107. The proximal end 122a of the header panel shield member 122 is fixed to the header panel portion 105a side, and the distal end 122b of the member comes into slide contact with the upper portion 110a of the closed hall door 110. Therefore, in the attaching operation S92 of the header panel smoke shut-off device, as shown in FIG. 24, the header panel shield member 122 is attached in a state in which the hall door 110 is opened. It is to be noted that when the attaching operation S92 of the header panel smoke shut-off device is performed before the attaching operation S8 of the hall doors, the attaching operation S92 can be easily performed without being obstructed by the hall doors 110.

In the attaching operation S93 of the door pocket smoke shut-off device, as shown in FIG. 25, the door pocket shield member 123 is attached to the end face 110f of the hall door 110 on the door pocket side, and an attaching position in the vertical direction is adjusted in an area of the attachment hole 123b formed to be long in the vertical direction. Consequently, a seal-tightness between the door pocket side edge portions 110e of the hall doors 110 and the jamb portions 105b of the gate frame 105 is adjusted into an optimum state.

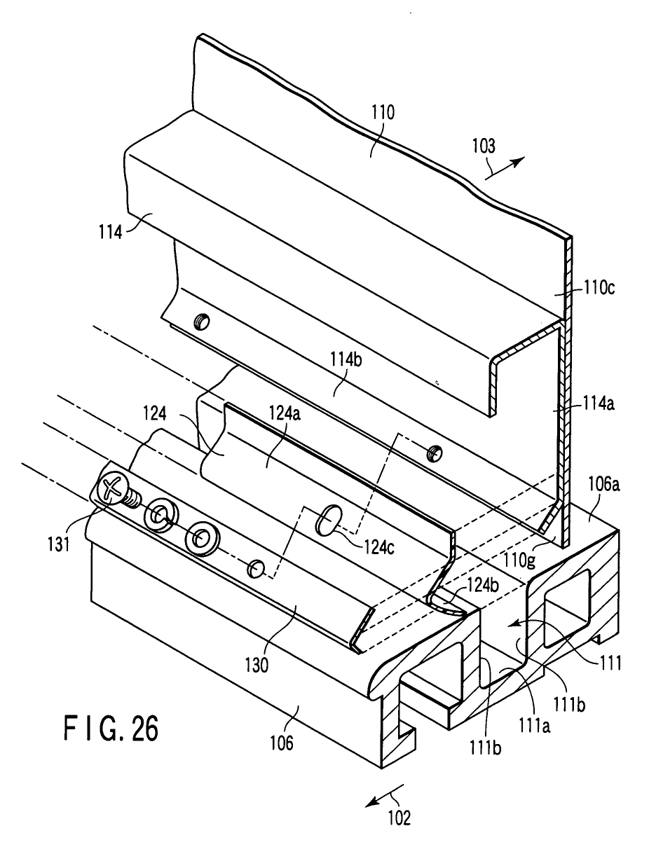

In attaching operation S94 of the doorsill smoke shut-off device, as shown in FIG. 26, the doorsill shield member 124 is attached to the lower portion 110b of the hall door 110, and an attaching position is adjusted in an area of the attachment hole 124c which is long in a direction extending from the proximal end 124a toward the distal end 124b of the doorsill shield member 124. Therefore, a seal-tightness between the lower portion 110b of the hall door 110 and the doorsill 106 is adjusted into an optimum state.

It is to be noted that the state in which the seal-tightness is optimum means a state in which the gaps made between the hall door 110 and the entrance part 104 are closed to shut off the ventilation of the elevator shaft 102 and the elevator hall 103. Moreover, the door pocket shield member 123 is pressed onto the jamb portion 105b of the gate frame 105, and the distal end 124b of the doorsill shield member 124 is pressed to the top 106a of the doorsill 106, strong enough to do not obstructed opening/closing operation of the hall doors 110. When the header panel shield member 122, the door pocket shield member 123, and the doorsill shield member 124 are unity bonded to the press plates 126, 128, and 130, respectively, an attaching operation can be easily performed.

Moreover, the attachment holes 123b, 124c of the door pocket shield member 123 and the doorsill shield member 124 are formed into oval shapes. Therefore, the smoke shut-off device is completed to a state in which the door pocket shield member 123 and the doorsill shield member 124 are temporally attached to the centers of the attachment holes 123b, 124c before the device is shipped from the plant. Since the operation for assembling the smoke shut-off device on the actual location is remained only the adjustment operation, the operation on the actual location will be reduced.

After completing the attaching operation S9 of the smoke shut-off device, the other operations, which do not include any operation that generates fire sparks, such as a welding or grinding, are performed. For example, installing of a traction machine and a control panel (in S10), piping and wiring for cable in the elevator shaft 102 (in S11), assembling of cage frames and balancing weights of the elevator 101 provided with the smoke shut-off device (in S12), assembling of the cage 140 (in S13), winding around ropes (in S15), trial and adjusting operations (in S16) and so on.

Moreover, an attaching operation and an adjusting operation for the smoke shut-off device 120, which is composed of the doorstop shield member 121, the header panel shield member 122, the door pocket shield member 123, and the doorsill shield member 124, is can be performed from the elevator shaft 102 side after performing the hall door attaching step S8. Therefore, the smoke shut-off device 120 can be attached or adjusted from the elevator shaft 102 side using a ceiling of the cage chamber 140 is used as a scaffold, after the assembling of the cage 140 is completed, and then the cage is prepared for an operation of the elevator. The smoke shut-off device 120 can be changed during maintenance or the like.

The gate frame 105, the doorsill 106, the hall doors 110, and the smoke shut-off device 120 are combined into a unit, and the unit is brought and attached into the elevator shaft 102 when the installing operation S5 of the gate frame, the attaching operation S6 of the header, the attaching operation S7 of the doorsill, the attaching operation S8 of the hall door, and the attaching operation S9 of the smoke shut-off device may be performed beforehand in the factory. In this case, in the operation on the actual location, there may only be performed a movement check and fine adjustment of the hall doors 110, and seal-tightness check and fine adjustment of the smoke shut-off device 120. Therefore, the operation on the actual location is substantially reduced.

It is to be noted that the assembling procedure shown in FIG. 27 shows an example of the procedure for assembling the elevator 101 provided with the smoke shut-off device. As described above, the attaching of the smoke shut-off device 120 may be performed before the hall door attaching operation. After the cage 140 is assembled, the operation to attach the smoke shut-off device 120 may be performed using the ceiling of the cage 140 as the scaffold.

As described above, according to embodiments of the present invention, the airtightness between the elevator hall and the elevator shaft is improved securely by the simple constitution, keeping a beautiful appearance, and the elevator shaft is prevented from being functioned as the chimney avoiding the fire developing at the fire happened in the elevator hall.

The above-described apparatus can be applied as a hall door apparatus of a sliding type door which requires seal-tightness.

What is claimed is:

1. A hall door apparatus of an elevator comprising:
a gate frame installed in an entrance port between an elevator hall and an elevator shaft in a building;
a doorsill arranged in a lower portion of said gate frame;
a door panel which is set on the doorsill to face the gate frame; and
a sealing member made of an elastic material which seals a gap between the door panel and at least the gate frame or the doorsill.

2. The hall door apparatus of the elevator according to claim 1, wherein
the gate frame has a pair of jamb portions disposed on opposite sides, and an header panel portion arranged between upper end portions of said jamb portions, and
the sealing member seals gaps between the door panel and the jamb portion and header panel portion of the gate frame, and between the door panel and the doorsill.

3. The hall door apparatus of the elevator according to claim 2, wherein
the door panel is of a biparting door type, and comprises a sealing member made of an elastic material which seals a gap between doorstop portions of the door panels.

4. The hall door apparatus of the elevator according to claim 2, wherein
the door panel is of a one-side sliding door type, and comprises a sealing member made of an elastic material which seals a gap between overlap portions of the door panels.

5. The hall door apparatus of the elevator according to claim 2, wherein
the sealing member which seals the gap between the door panel and the header panel portion of the gate frame has a base portion and a lip portion, wherein
said base portion is bonded to a press plate, and fastened to the header panel portion together with the press plate via a fastening member; and
said lip portion extends unity from said base portion, and keeps an posture leaning toward the surface of the door panel while a distal-end edge portion of the lip portion is curved as an arc, and elastically comes into contact with the surface of the door panel to seal the gap.

6. The hall door apparatus of the elevator according to claim 2, wherein
the sealing member which seals the gap between the door panel and the jamb portion of the gate frame has a base portion and a lip portion, wherein
said base portion is bonded to a press plate, and fastened to a side end portion of the door panel together with said press plate via a fastening member, and;
said lip portion extends unity from the base portion, and keeps an posture leaning toward the surface of the jamb portion while a side face of the lip portion is curved as an arc, and elastically comes into contact with a corner portion of the jamb portion to seal the gap.

7. The hall door apparatus of the elevator according to claim 2, wherein
the sealing member which seals the gap between the door panel and the doorsill has a base portion and a lip portion, wherein
said base portion is bonded to a press plate, and fastened to a lower portion of the door panel together with the press plate via a fastening member,
the lip portion extends integrally from the base portion, and keeps an posture leaning toward a top of the doorsill while a distal-end edge portion of the lip portion is curved as an arc, and elastically comes into contact with the top of the doorsill to seal the gap.

8. The hall door apparatus of the elevator according to claim 5, wherein the fastening member is inserted from the internal side of the elevator shaft into the header panel portion to fix the sealing member to the header panel portion.

9. The hall door apparatus of the elevator according to claim 6, wherein the fastening member is inserted from the internal side of the elevator shaft into the door panel to fix the sealing member to the door panel.

10. The hall door apparatus of the elevator according to claim 7, wherein the fastening member is inserted from the internal side of the elevator shaft into the door panel to fix the sealing member to the door panel.

11. The hall door apparatus of the elevator according to claim 1, wherein the sealing member is made of at least one selected from the group consisting of fluorine-based rubber, silicon rubber, vinyl chloride, and ethylene propylene rubber.

12. The hall door apparatus of the elevator according to claim 2, wherein the sealing members provided for at least one of the door panel and the header panel portion, the door panel and the gate frame, and the door panel and the doorsill are made of an ethylene propylene rubber.

13. The hall door apparatus of the elevator according to claim 2, wherein
the sealing member has a base portion and a lip portion, wherein
said base portion is bonded a press plate, said press plate has a substantially U-shaped vertical section, and said press plate sandwiches the sealing member in said U-shape to hold the sealing member.

14. The hall door apparatus of the elevator according to claim 1, wherein the doorsill is provided with a recessed portion which is formed over a predetermined span in a longitudinal direction of an upper portion of the doorsill.

15. The hall door apparatus of the elevator according to claim 1, wherein
the doorsill is provided with a guide groove in an upper portion of the doorsill, said guide groove is inserted a plugging member which closes the guide groove in a zone crossing the gate frame.

16. The hall door apparatus of the elevator according to claim 1, wherein in the sealing member includes a door pocket shield member which seals the gap between the door panel and the jamb portion of the gate frame, said door pocket shield member has an oval attachment hole which is long along a vertical direction of the door panel.

17. The hall door apparatus of the elevator according to claim 1, wherein in the sealing member includes a doorsill shield member which seals the gap between the door panel and the doorsill, said doorsill shield member has an oval attachment hole which is long along a direction from a proximal end of the doorsill shield member fixed to the door panel to a distal end of the doorsill shield member brought into contact with the top of the doorsill.
